(19) United States
(12) Patent Application Publication
(10) Pub. No.: US 2025/0321540 A1
(43) Pub. Date: Oct. 16, 2025

(54) TIMEPIECE CALENDAR SYSTEM

(71) Applicant: ROLEX SA, Geneva (CH)

(72) Inventors: Valentine Pennestri, Sergy (FR); Denis Rudaz, Segny (FR)

(73) Assignee: ROLEX SA, Geneva (CH)

(21) Appl. No.: 19/174,857

(22) Filed: Apr. 9, 2025

(30) Foreign Application Priority Data
Apr. 10, 2024 (EP) 24169550.1

(51) Int. Cl. G04B 19/253

(52) U.S. Cl. CPC G04B 19/25353

(57) ABSTRACT

The instantaneous jump timepiece calendar system (100) includes an energy accumulation and restoration device including an energy accumulator (4) and a cam (33), a date mobile (1), a month mobile (2), a first element (7) for indexing the date mobile (1), a second element (8) for indexing the month mobile (2), a mobile (3) for driving the date mobile by restoring energy from the energy accumulator (4), and an element (6b) for driving the month mobile by restoring energy from the energy accumulator (4), the element (6b) for driving the month mobile being arranged and/or configured to limit the movement of the month mobile after the driving of the month mobile.

### CROSS-REFERENCE TO RELATED APPLICATION

This application claims priority of European patent application No. EP24169550.1 filed Apr. 10, 2024, the content of which is hereby incorporated by reference herein in its entirety.

### FIELD OF THE INVENTION

The invention concerns a timepiece calendar system. The invention also concerns a timepiece movement comprising such a timepiece calendar system. The invention further concerns a timepiece comprising such a timepiece movement or such a timepiece calendar system. The invention further concerns a method of operating such a timepiece calendar system or such a timepiece movement or such a timepiece. The invention further relates to an indicator mobile, notably a month indicator mobile, for a timepiece calendar system.

### BACKGROUND ART

Complete calendars are known in the timepiece art. In particular, the work “Les montres calendriers modernes” by B. Humbert covers a good number of examples of complete calendars known from the fifties. There can notably be found therein a description of a calendar plate from Vacheron Constantin with four indications that is characteristic of the epoque and in which a date mobile with 31 teeth is placed at the center of the movement. It is actuated periodically by a drive finger completing one revolution in 24 hours because of the effect of the rotation of an hour wheel itself driven by a drive member of a base movement. The month mobile is for its part updated once per month by the effect of a finger carried by an intermediate mobile similar or identical to the date mobile itself interengaged with the date mobile. Whether this concerns the indication of the day of the month or the indication of the month, these indications are driven in a “dragging” manner, which is to say that the indications are driven over several minutes or even several hours. The speed of rotation of the drive finger is constant and corresponds to the speed of the 24 h mobile to which the finger is fixed, which is itself interengaged with the hour wheel. The indications of the day of the month and the month therefore remain the same over several minutes or even several hours, until the respective jumpers of the date and month mobiles restore their energy by reindexing said mobiles. Moreover, the indications of the date and the month can be out of phase over such a time span.

The patent application CH685585 discloses a mobile tooth of a date mobile that is elastically urged against a months programming cam disposed concentrically with the date mobile so as to provide an annular calendar with dragging jumps. The kinematic chain of the date and that connecting the date mobile to the mobile supporting the month programming cam are particularly long and complex. They notably induce a certain number of stages in contradiction with an objective of compactness of the calendar or of the movement incorporating such a calendar. Furthermore, such a chain is greedy for energy and therefore does not favor the implementation of a complete calendar with instantaneous jumps.

The patent application EP1734419 discloses a perpetual calendar with instantaneous jumps that can take the form of a complete calendar. To this end the calendar comprises a cam for programming the months that is off-center relative to a date mobile and a snail calendar cam. These various cams are designed to cooperate with a number of levers and so their construction is particularly complex. In particular, the months programming cam is designed to position a month lever connected to a rack designed to drive a lever provided with a ratchet itself designed to actuate a tooth of a date mobile.

The patent application EP3567438 discloses a calendar provided with a desmodromic system comprising a months programming cam cooperating with a cam follower, the latter being designed to allow or to prohibit retraction of a mobile tooth mounted on a date mobile. The months programming cam is concentric with the date mobile and so the cam follower is necessary to establish a connection between the month cam and the tooth mounted to be mobile or movable on the date mobile.

### SUMMARY OF THE INVENTION

The aim of the invention is to provide a timepiece drive device enabling improvement of devices known in the prior art. In particular, the invention proposes a reliable, simple system as an alternative to existing systems and making it possible to circumvent architecture and construction constraints.

In accordance with a first aspect of the invention, objects are defined by the following propositions.

1. An instantaneous jump timepiece calendar system (100) comprising:
an energy accumulation and restoration device comprising an energy accumulator (4) and a cam (33),
a date mobile (1),
a month mobile (2),
a first element (7) for indexing the date mobile (1),
a second element (8) for indexing the month mobile (2),
a mobile (3) for driving the date mobile by restoring energy from the energy accumulator (4), and
an element (6b) for driving the month mobile by restoring energy from the energy accumulator (4),
the element (6b) for driving the month mobile being arranged and/or configured to limit the movement of the month mobile after the driving of the month mobile.

2. The timepiece calendar system (100) according to proposition 1, characterized in that the second indexing element (8) for the month mobile (2) produces a torque for holding the month mobile (2) in tension 2 times less than or 1.5 times less than the torque for retaining the date mobile (1) in position produced by the first indexing element (7) of the date mobile (1).

3. The timepiece calendar system (100) according to either one of propositions 1 or 2, characterized in that the first indexing element is a jumper (7) cooperating with teeth (1a) of the date mobile.

4. The timepiece calendar system (100) according to any one of propositions 1 to 3, characterized in that the second indexing element is a jumper (8) cooperating with teeth (2a) of the month mobile.

5. The timepiece calendar system (100) according to any one of propositions 1 to 4, characterized in that the drive mobile (3) comprises a first finger (31), such as a pin, adapted to cooperate through contact with teeth (1a) of the date mobile.

6. The timepiece calendar system (100) according to any one of propositions 1 to 5, characterized in that the drive mobile (3) comprises a second finger (32) adapted to cooperate through contact with an additional tooth (12b) of the date mobile.

7. The timepiece calendar system (100) according to any one of propositions 1 to 6, characterized in that the drive mobile (3) comprises the cam (33).

8. The timepiece calendar system (100) according to any one of propositions 1 to 7, characterized in that the date mobile (1) pivots about a first axis (A1), the month mobile (2) pivots about a second axis (A2) and the drive mobile (3) pivots about a third axis (A3), the first axis (A1), the second axis (A2) and the third axis (A3) being distinct.

9. The timepiece calendar system (100) according to proposition 8, characterized in that the first axis (A1) is at the center of the calendar system (100) and/or at the center of a timepiece movement (200) and/or at the center of a timepiece (300).

10. The timepiece calendar system (100) according to any one of propositions 1 to 9, characterized in that the element (6b) for driving the month mobile comprises a third finger (6b) adapted to cooperate through contact with teeth (2a) of the month mobile.

11. The timepiece calendar system (100) according to any one of propositions 1 to 10, characterized in that the element (6b) for driving the month mobile comprises a first surface (61b) forming an abutment for the month mobile (2), the surface (61b) being adapted to limit the movement of the month mobile (2) by cooperating with a second surface (21a) of the month mobile (2).

12. The timepiece calendar system (100) according to any one of propositions 1 to 11, characterized in that the system comprises:
a day mobile (5),
a third element (9) for indexing the day mobile (5),
a third element (38) for driving the day mobile by restoring energy from the energy accumulator (4).

13. The timepiece calendar system (100) according to any one of propositions 1 to 12, characterized in that the third element (38) for driving the day mobile is adapted and/or configured to limit the movement of the day mobile after the driving of the day mobile.

14. The timepiece calendar system (100) according to any one of propositions 1 to 13, characterized in that the system is a simple or annual or semi-perpetual or perpetual calendar system.

15. A timepiece movement (200) comprising a system according to any one of propositions 1 to 14.

16. A timepiece (300), in particular a wristwatch, comprising a system (100) according to any one of propositions 1 to 14 and/or a timepiece movement according to proposition 15.

In accordance with a second aspect of the invention, objects are defined by the following propositions.

17. A timepiece calendar system (100), the system comprising:
a date mobile (1) pivoting about a first axis (A1);
a first element (32) driving the date mobile, such as a finger,
a second element (12) for driving the date mobile, comprising for example a tooth (12a) for driving the date mobile, the second drive element (12) being mounted on the date mobile (1) to be mobile between a retracted position and a driving position, and
a month cam (22) pivoted about a second axis (A2),
the month cam (22) being adapted to cooperate with the second element (12) for driving the date mobile so that, depending on the position of the month cam (22), it allows or prohibits retraction of the second element (12) for driving the date mobile, the first and second axes being distinct.

18. The timepiece calendar system (100) according to proposition 17, characterized in that the month cam (22) is adapted so that:
at least one first position of the month cam (22) allows retraction of the second element (12) for driving the date mobile through the action of the first element (32) for driving the date mobile, and
through direct contact of the month cam (22) with the second element (12) for driving the date mobile at least one second position of the month cam (22) prohibits retraction of the second element (12) for driving the date mobile through the action of the first element (32) for driving the date mobile.

19. The timepiece calendar system (100) according to either one of propositions 17 or 18, characterized in that the timepiece calendar system (100) comprises a month display member, the month display member and the month cam (22) forming a single component (24).

20. The timepiece calendar system (100) according to any one of propositions 17 to 19, characterized in that the second element (12) for driving the date mobile comprises a lever pivoted on the date mobile (1) about a third axis (A12).

21. The timepiece calendar system (100) according to proposition 20, characterized in that the amplitude of pivoting of the lever 12 about the third axis (A12) is approximately 7° or approximately 0.5 mm at the level of a conformation (12b) of the second element (12) for driving the date mobile, such as a pin (12b), each coming into contact with the month cam (22).

22. The timepiece calendar system (100) according to any one of propositions 17 to 21, characterized in that the timepiece calendar system (100) comprises:
a first element (11a) for limiting the movement of the second element (12) for driving the date mobile relative to the date mobile (1), such as a pin, and
a second element (12c) for limiting the movement of the second element (12) for driving the date mobile relative to the date mobile (1), such as an opening,
the first and second limitation elements cooperating with one another.

23. The timepiece calendar system (100) according to any one of propositions 17 to 22, characterized in that the timepiece calendar system (100) is an annual or semi-perpetual or perpetual calendar system.

24. The timepiece calendar system (100) according to any one of propositions 17 to 23, characterized in that the timepiece calendar system (100) comprises a device for accumulating and restoring energy comprising an energy accumulator (4) and a cam (33) so as to constitute an instantaneous jump calendar system.

25. The timepiece calendar system (100) according to any one of propositions 17 to 24, characterized in that the timepiece calendar system (100) comprises a mobile (3) for driving the date mobile (1), the drive mobile including the first element (32) for driving the date mobile (1) and a third element (31) for driving the date mobile (1).

26. The timepiece calendar system (100) according to propositions 24 and 25, characterized in that the timepiece calendar system (100) comprises the cam (33).

27. The timepiece calendar system (100) according to any one of propositions 17 to 26, characterized in that the mobile (3) for driving the date mobile (1) pivots about a third axis (A3) distinct from the first axis (A1) and the second axis (A2), in particular parallel to the first axis (A1) and to the second axis (A2).

28. The timepiece calendar system (100) according to any one of propositions 17 to 27, characterized in that the system comprises:
a third element (31) for driving the date mobile, such as a finger or a pin,
a fourth element (1a) for driving the date mobile comprising for example teeth (1a) for driving the date mobile, in particular external teeth (1a) for driving the date mobile.

29. The timepiece calendar system (100) according to any one of the propositions 17 to 28, characterized in that the system comprises a frame (99) and in that the first and second axes are fixed axes relative to the frame (99).

30. The timepiece calendar system (100) according to any one of the propositions 17 to 29, characterized in that the system is arranged so that the second element (12) for driving of the date mobile is freely retractable.

31. The timepiece calendar system (100) according to any one of the propositions 17 to 30, characterized in that the system is arranged so that the second element (12) for driving of the date mobile acts directly by contact with the month cam (22).

32. The timepiece calendar system (100) according to any one of the propositions 17 to 31, characterized in that the system comprises a month mobile (2) including:
a month indicator disc (23), and
the month cam (22),
the month indicator disc and the month cam forming a one-piece assembly obtained by machining the whole from the mass or by fixing the month indicator disc and the month cam, in particular by gluing and/or welding and/or brazing,
and/or
the month cam has an annular shape,
and/or
the indicator disk (23) being inscribed in a first cylinder having a diameter D1, the cam (22) being inscribed in a second cylinder having a diameter D2 and the cam having an opening (221) in which a third cylinder having a diameter D3 can be inscribed, the diameters D1, D2 and D3 being such that
D2<D1, in particular D2<0.9×D1, and
D2>D3, in particular D2>D3>0.5×D2, in particular D2>D3>0.8×D2.

33. A timepiece movement (200) comprising a system according to any one of propositions 17 to 32.

34. A timepiece (300), in particular a wristwatch, comprising a system (100) according to any one of propositions 17 to 32 and/or a timepiece movement according to proposition 33.

35. A method of operating a timepiece calendar system (100) according to any one of propositions 17 to 32 or a timepiece movement (200) according to proposition 33 or a timepiece (300) according to proposition 34, the method comprising the following steps:
positioning the month cam (22) in a first position and action of the first element (32) for driving the date mobile on the second element (12) for driving the date mobile so as to drive the date mobile, and
positioning the month cam (22) in a second position and action on the first element (32) for driving the date mobile on the second element (12) for driving the date mobile so as to retract the second element (12) for driving the date mobile without driving the date mobile.

36. An indicator mobile (2), notably a month indicator mobile (2), for a timepiece calendar system (100), the indicator mobile (2) including:
an axis (A2),
a indicator disc (23), and
a cam (22),
the indicator disc and the cam forming a one-piece assembly obtained by machining the whole from the mass or by fixing the indicator disc and the cam, in particular by gluing and/or welding and/or brazing,
and/or
the cam has an annular shape,
and/or
the indicator disk (23) being inscribed in a first cylinder having a diameter D1, the cam (22) being inscribed in a second cylinder having a diameter D2 and the cam having an opening (221) in which a third cylinder having a diameter D3 can be inscribed, the diameters D1, D2 and D3 being such that
D2<D1, in particular D2<0.9×D1, and
D2>D3, in particular D2>D3>0.5×D2, in particular D2>D3>0.8×D2.

Unless there is a technical or logical incompatibility, any object according to the first aspect of the invention may be combined with any object according to the second aspect of the invention.

### BRIEF DESCRIPTION OF THE DRAWINGS

The appended drawings represent by way of example one embodiment of a timepiece according to the invention.

FIG. 1 is a view of one embodiment of a timepiece according to the invention.

FIG. 2 is a view of a calendar system used in this embodiment of the timepiece according to the invention.

FIG. 3 is a view of a calendar drive system used in this embodiment of the timepiece according to the invention.

FIG. 4 is an exploded perspective view of a drive mobile used in this embodiment of the timepiece according to the invention.

FIG. 5 is a view in axial section of a month mobile used in this embodiment of the timepiece according to the invention.

FIG. 6 is a view of the calendar system on April 30th just before midnight.

FIG. 7 is a view of the calendar system in a first jump phase when the display jumps from April 30th to May 1st.

FIG. 8 is a detail view of the calendar system in its FIG. 7 configuration, this view showing in detail the interaction of the date and month mobiles.

FIG. 9 is a view of the calendar system in a second jump phase when the display jumps from April 30^{th} to May 1^{st}.

FIG. 10 is a view of the calendar system just before the display jumps from April 30^{th} to May 1^{st}.

FIG. 11 is a view of the calendar system in a first jump phase when the display jumps from May 30^{th} to May 31^{st}.

FIG. 12 is a detail view of the calendar system in its FIG. 11 configuration, this view detailing the interaction of the date and the month mobiles.

FIG. 13 is a view of the calendar system in a second jump phase when the display jumps from May 30^{th} to May 31^{st}.

### DETAILED DESCRIPTION OF PARTICULAR EMBODIMENTS

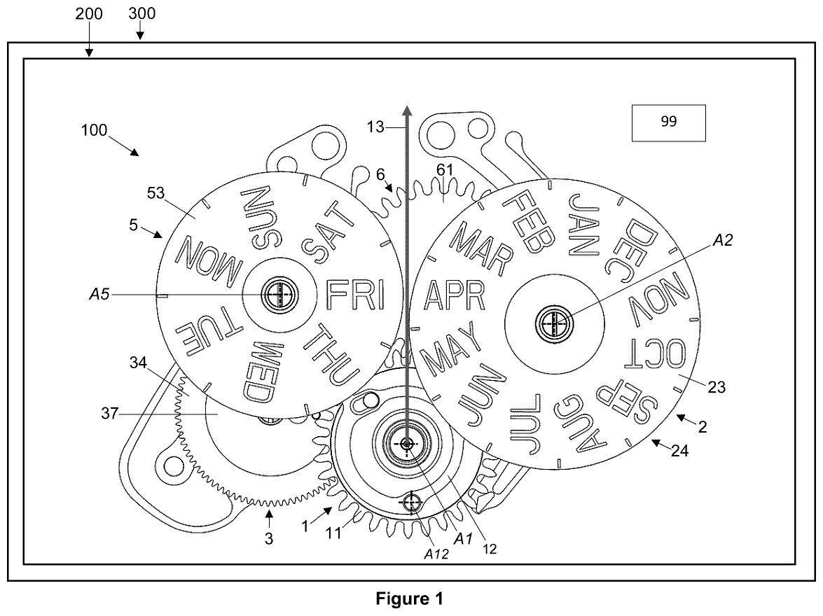

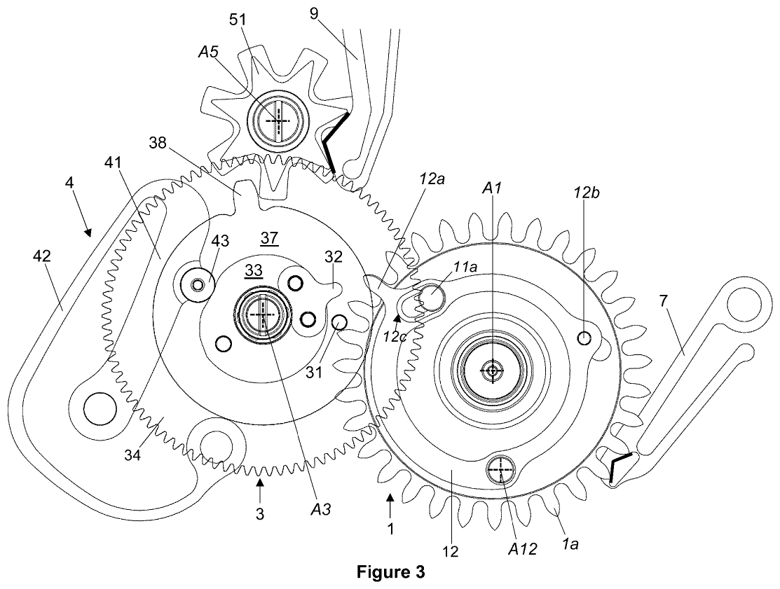

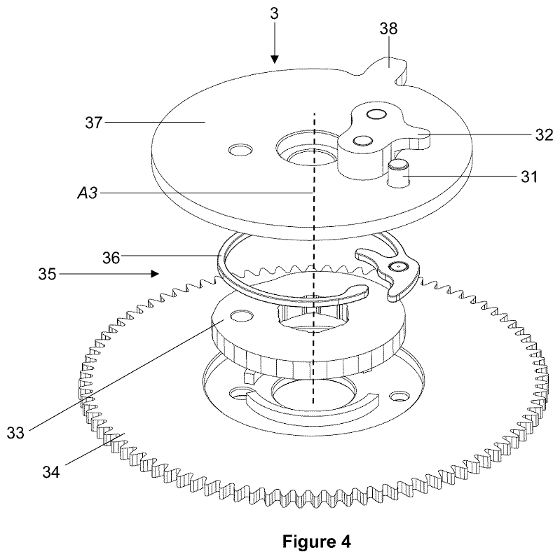

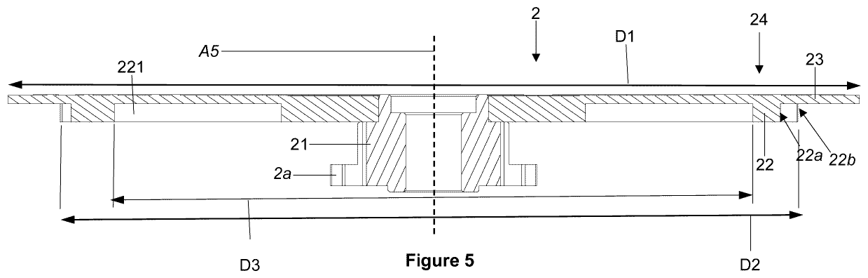

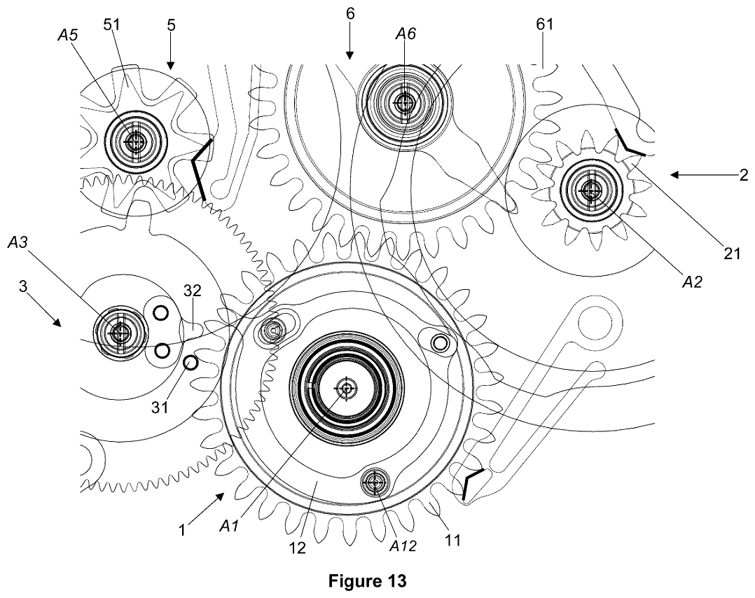

One embodiment of a timepiece is described hereinafter with reference to FIGS. 1 to 13.

The timepiece 300 is for example a watch, in particular a wristwatch. The timepiece 300 includes a timepiece movement 200 intended to be mounted in a timepiece case or casing in order to protect it from the exterior environment.

The timepiece movement 200 is a mechanical movement, notably an automatic movement, or a hybrid movement or an electronic movement.

The timepiece movement 200 comprises a timepiece calendar system 100. The timepiece calendar system 100 is preferably an instant jump system.

The calendar system can be a simple or annual or semi-perpetual or perpetual calendar system.

In accordance with a first aspect, the timepiece calendar system 100 comprises:
an energy accumulation and restoration device comprising an energy accumulator 4 and a cam 33,
a date mobile 1,
a month mobile 2,
a first element 7 for indexing the date mobile 1,
a second element 8 for indexing the month mobile 2,
a mobile 3 for driving the date mobile by restoring energy from the energy accumulator 4, and
an element 6b for driving the month mobile by restoring energy from the energy accumulator 4.

The element 6b for driving the month mobile is arranged and/or configured to limit the movement of the month mobile after the driving of the month mobile.

In accordance with a second aspect the timepiece calendar system 100 comprises:
the date mobile 1 pivoted about an axis A1,
an element 32 for driving the date mobile, such as a finger 32,
an element 12 for driving the date mobile, comprising for example a tooth 12a for driving the date mobile, the drive element 12 being mounted on the date mobile 1 to be mobile between a retracted position and a driving position, and
a month cam 22 pivoted about an axis A2, the month cam 22 being adapted to cooperate with the element 12 for driving the date mobile so that, depending on the position of the month cam 22, it allows or prohibits retraction of the element 12 for driving the date mobile, notably through the action of the element 32 for driving the date mobile, the first and second axes A1 and A2 being distinct.

The month cam 22 is advantageously such that:
at least one first position of the month cam 22 allows retraction of the element 12 for driving the date mobile through the action of the element 32 for driving the date mobile, and
at least one second position of the month cam 22 prohibits, through direct contact of the month cam 22 with the element 12 for driving the date mobile, retraction of the element 12 for driving the date mobile through the action of the element 32 for driving the date mobile.

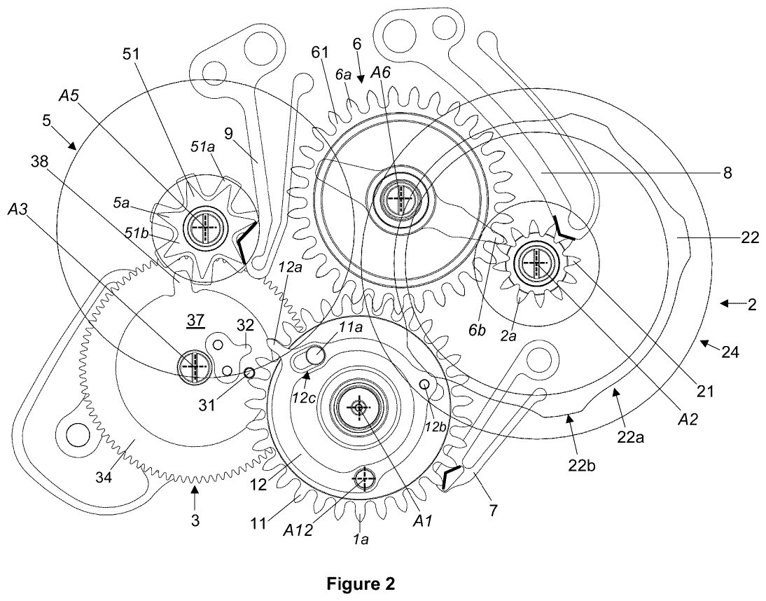

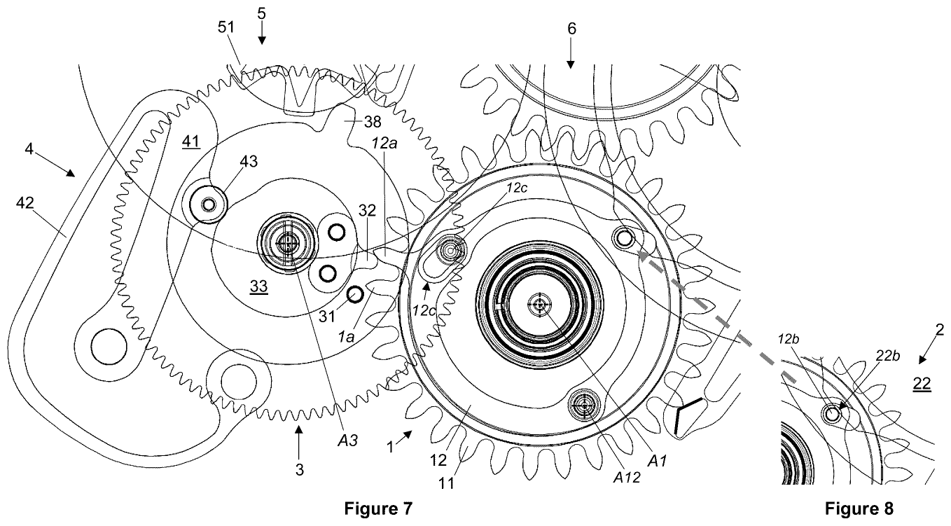

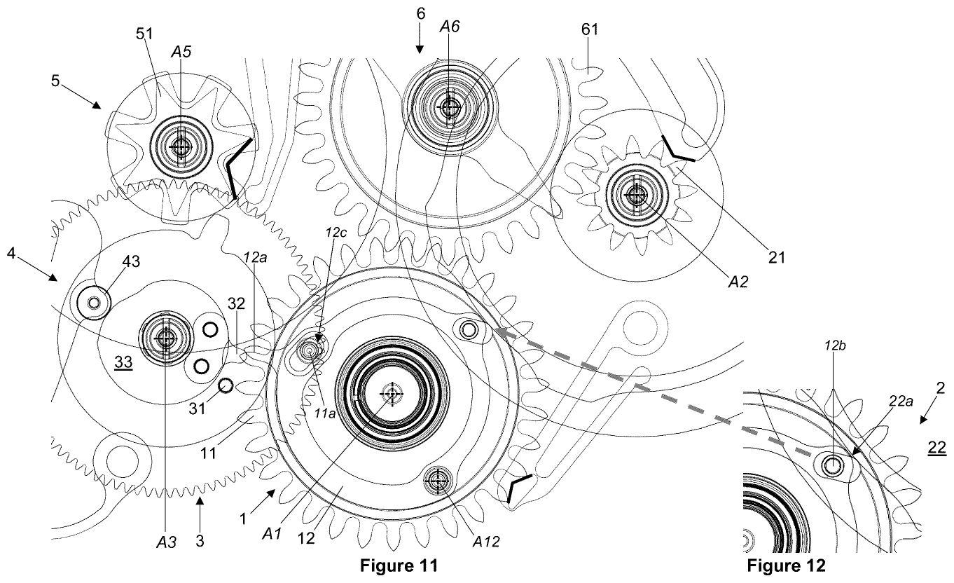

In this embodiment the date mobile 1 is positioned along the axis A1 at the center of the calendar system 100 or of a calendar module or of the movement 200 incorporating the calendar system 100. The date mobile 1 comprises a wheel 11 with 31 teeth 1a and a lever 12 mounted to be mobile or movable in rotation on the wheel 11 about an axis A12 as represented in FIGS. 1 and 2. The lever 12 constitutes the driving element 12 mounted on the date mobile 1 to be mobile between a retracted position (represented in FIGS. 11 and 12) and a driving position (notably represented in FIGS. 7 and 8). The amplitude of the pivoting of the lever 12 about the axis A12 is approximately 7° or approximately 0.5 mm at the level of the conformation 12b of the lever 12, such as a pin 12b, intended to come into contact with the month cam. To define this amplitude, the system preferably comprises:
an element 11a for limiting the movement of the lever 12 relative to the date mobile 1, such as a pin, and
an element 12c for limiting the movement of the lever 12 relative to the date mobile 1, such as an opening, these limiting elements 11a and 12c cooperating with one another to limit the movement of the lever 12 relative to the wheel 11.

The lever 12 is designed to cooperate directly with the month mobile 2 pivoted about the axis A2, in particular with the months programming cam 22 mounted on or fixed to a month pinion 21, as represented in FIG. 2. The month cam 22 comprises circular portions 22a and radial projections 22b. Each of these radial projections 22b is configured and/or adapted to serve as an abutment against the conformation 12b of the lever 12.

The direct cooperation between the lever 12 and the month cam 22, in particular the contact between the pin 12b and a projection 22b, enables the calendar to be driven by an additional step at the end of a month of 30 days or possibly a month of fewer than 30 days (i.e. the month of February), as described below.

The lever 12 is advantageously adapted so that the conformation 12b is moved substantially orthoradially relative to the axis A1 or to form an angle of less than 45° to the direction orthoradial to the axis A1 during retraction of the lever 12.

The mobiles 1 and 2 are driven instantaneously, notably because of the effect of the drive mobile 3. The mobile 3 pivots about an axis A3. The mobile 3 effects a complete revolution about its axis A3 every 24 hours. The mobile 3 comprises an element 31, such as a finger or a pin 31, which is designed to drive the mobile 1 by one angular step every 24 hours through cooperation by contact with one of the teeth 1a of the wheel 11. The mobile 3 also comprises the drive element 32 that is designed to exert an action on the lever 12, in particular on the tooth 12a of the lever, at the end of each month. As described below, this action has for effect:
retracting the lever 12 at the end of long months, and
driving the mobile 1 at the end of short months.

The jumps are instantaneous because of the energy accumulator 4, which is designed to cooperate with the cam 33 of the mobile 3. The accumulator 4 comprises a lever 41 biased against the cam 33 by a spring 42. The lever 41 and the spring 42 can be obtained by permanently assembling a plurality of parts or be made in one piece (by shaping a single block of material) in order to form a single component 4. The cooperation between the lever 41 and the cam 33 is preferably effected via a roller 43 mounted to be mobile in rotation at the level of a portion, in particular an end, of the lever 41.

The mobile 3 also comprises a wheel 34 that enables it to be connected, notably by meshing with it, to a base movement via an appropriate kinematic chain, in particular an hour wheel (not represented). The fingers 31, 32 and the cam 33 are advantageously connected to this wheel 34 via a unidirectional connecting device 35. This device comprises an elastic pawl 36 connecting the wheel 34 to a disc 37 on which the fingers 31, 32 are mounted. In particular, the elastic pawl 36 acts on a conformation of the wheel 34 and a conformation of the disc 37 so as to induce counterclockwise rotation of the elements 31, 32, 33 because of the effect of counterclockwise rotation of the wheel 34. When the wheel 34 is driven in the clockwise direction the elements 31, 32, 33 are not driven and remain in position because of the effect of the lever 41 and its spring 42, which act against the cam 33.

In the embodiment represented, the disc 37 also comprises a guide member 38, such as a finger 38, which is designed to drive a day mobile 5 by one angular step every 24 hours through cooperation by contact with one of the seven teeth 5a of a wheel or a star wheel 51.

The mobile 3 is therefore designed to drive instantaneously:
the date mobile 1, once per day or once every 24 hours,
the day mobile 5, once per day or once every 24 hours, and
the month mobile 2, once per month.

The month mobile 2 is connected to the date mobile 1 by a particularly simple kinematic chain consisting of an intermediate mobile 6 comprising a wheel 61 with 31 teeth 6a that mesh with the 31 teeth 1a of the wheel 11 and a finger 6b designed to drive the mobile 2 by one angular step through cooperation by contact with one of the teeth 2a of the pinion 21 secured to the month cam 22.

Each of the mobiles 1, 2, 5 is preferably indexed in position by a respective indexing element or jumper 7, 8, 9, which makes it possible to hold the date, day and month indicator members in the display. The jumper 7 cooperates with the teeth 1a of the date mobile. The jumper 8 cooperates with the teeth 2a of the month mobile. The jumper 9 cooperates with teeth 51a of the wheel or the star wheel 51.

The date indicator member can be a central hand 13 and the month and day indicator members can be discs 23 and 53 as represented in FIG. 1.

The cam 22 and the disc 23 preferably form a single component 24. In other words, the circular portions 22a and the radial projections 22b are made or formed directly under the disc 23, on the side opposite that with the month indications. The circular portions 22a are optional. Thus just the radial projections 22b could be made or formed directly on the disc 23.

Furthermore, the annual calendar system is particularly simple and compact, with a kinematic chain consisting only of:
an intermediate mobile 6, and
a cam 22 and a month indicator member 23 simply reduced to the same component 24.

In an alternative embodiment mounting the finger 6b directly on the mobile 1 could be envisaged so that the mobile 1 is able to drive the month mobile 2 directly, with no intermediate mobile 6.

This arrangement is made possible by the fact that the cam 22 pivoted about the axis A2 is off-center relative to the date mobile 1 pivoted about the axis A1. In other words, the cam 22 is off-axis or off-center relative to the date mobile 1 on which the lever 12 designed to cooperate with the cam 22 is mounted to be mobile or movable, the advantage of which is that the date indicator and the month indicator cohabit in the simplest possible way.

Furthermore, the jumps of these members are preferably instantaneous and synchronized thanks to the energy accumulator 4, the mobile 3 and the finger 6b. As mentioned above, the finger 6b is adapted and/or configured to limit the movement of the month mobile 2 after the driving of the month mobile 2. To this end, the finger 6b is configured and/or adapted to constitute an abutment for the pinion 21 following the change of date. To this end, the finger 6b comprises a surface 61b forming an abutment for the month mobile 2. In fact, after having driven a tooth 2a of the teeth 21, the finger 6b is immobilized for 24 hours in a position in which it constitutes, in particular in which the surface 61b constitutes, an abutment for limiting the movement of the month mobile 2 through cooperation with a surface 21a of the month mobile 2. The surface 61b therefore constitutes an abutment for the tooth of the teeth 21 coming just after the tooth that has just been driven, in particular for the surface 21a of that tooth. This operating principle therefore makes it possible to minimize the torque for retaining the jumper 8 while avoiding all risk of unintentional additional jumping of the month display member following the change of date. This retaining torque can be minimized as much as the month mobile 2 is simplified as much as possible by integrating the cam 22 and the member 23 in the same component 24. The mobile 2 can therefore be reduced to two components, namely a pinion 21 indexed in position by the jumper 8 and a component 24 integrating the display member 23 and the months programming cam 22. It is therefore possible to set the dimensions of the calendar system so that the element 8 for indexing the month mobile 2 produces a retaining torque in the position of the months profile 2 times less or 1.5 times less than the torque for retaining the date mobile in position produced by the element 7 for indexing the date mobile 1.

In a similar manner to the finger 6b, the element 38 for driving the day mobile can be adapted and/or configured to limit the movement of the day mobile following the driving of the day mobile 5 by one angular step.

An embodiment of a method of operating the timepiece calendar system 100 described above or the timepiece movement 200 described above or the timepiece 300 described above is described next.

The method comprises the following steps:
positioning the month cam 22 in a first position and action of the element 32 for driving the date mobile on the second element 12 for driving the date mobile so as to drive the date mobile, this step occurring at the end of short months (April, June, September, November), and
positioning the month cam 22 in a second position and action of the element 32 for driving the date mobile on the element 12 for driving the date mobile so as to retract the element 12 for driving the date mobile without driving the date mobile, this step occurring at the end of long months (January, March, May, July, August, October, December).

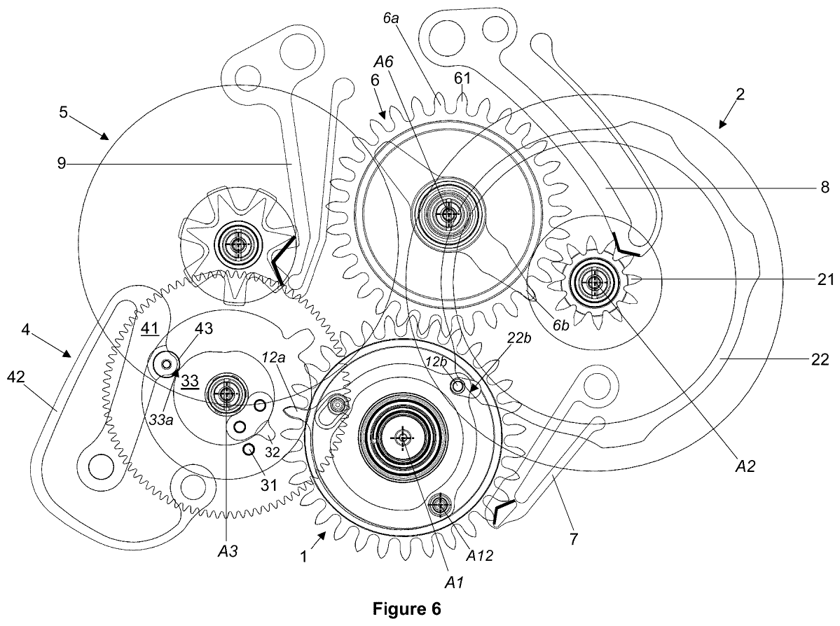

FIG. 6 represents the timepiece system on April 30 just before midnight, that is to say just before the calendar indications jump. In this configuration the roller 43 is at the top 33a of the cam 33. The energy accumulator 4 is therefore ready to restore the accumulated energy at midnight so as to generate rotation of the fingers 31, 32 that in this movement are constrained to rotate with the cam 33.

FIG. 7 represents the calendar system during a first phase of the jump of the calendar indications. Given that the month of April is a month comprising 30 days, the pin 12b is designed to come to abut against a projection 22b of the months programming cam 22 because of the action of the tooth 32 against the tooth 12a, as can be seen more particularly in FIG. 8. The fact that the pin 12b abuts against the projection 22b prevents rotation of the lever about the axis A12 and therefore generates rotation of the mobile 1 by one angular step about the axis A1.

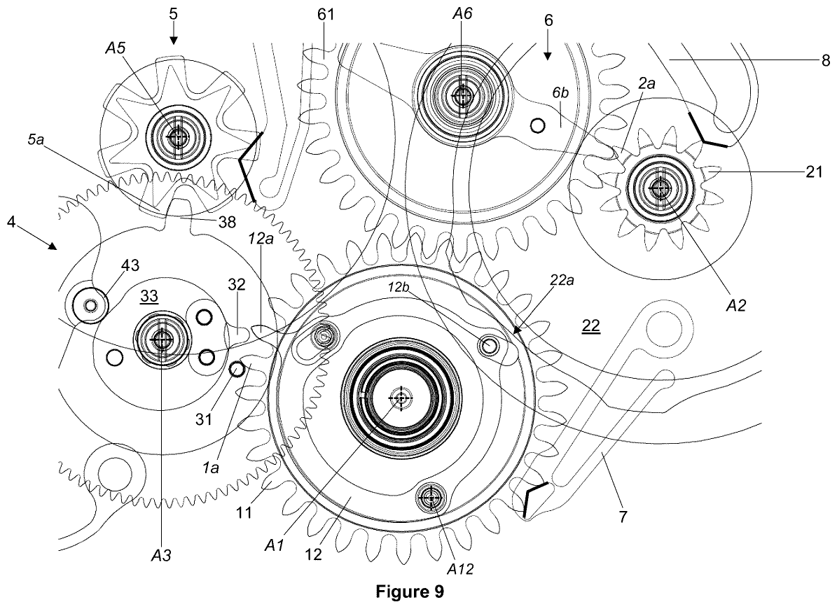

FIG. 9 represents the calendar system during a second phase of the jumping of the calendar indications. The finger 31 drives a tooth 1A of the wheel 11 so that the mobile 1 turns by one supplementary angular step about the axis A1. During this phase, the mobile 6 also turns by one angular step about the axis A6 and so the finger 6b drives a tooth 2a of the month mobile 2 and therefore allows rotation of the mobile 2, in particular of the cam 22 and the display member 23, by one angular step.

During the first phase the finger 32 applies a force against the jumper 7 until the latter restores the energy accumulated by its return spring. During the second phase, the finger 31 applies a force against the jumper 7 and against the jumper 8 (and against the jumper 9 if the calendar system includes a day display device), until they restore the energy accumulated by their respective return springs. As mentioned above, the torque produced by the jumper 8 against the mobile 2 is 2 times less than or 1.5 times less than the torque produced by the jumper 7 against the mobile 1. Such a choice makes it possible to minimize the energy accumulated by the accumulator 4 and therefore makes it possible to minimize the variations of amplitude of the oscillator of the movement driving the calendar system. Such a choice is favored by the fact that the inertia of the mobile 2 is minimized because the cam 22 is integrated into the member 23, these elements forming a single component 24.

As mentioned above, in order to render secure the operation of the calendar system, and notably to prevent all risk of unintended additional jumps, the finger 6b is designed to remain in the teeth 2a of the mobile 2 once the date jump has been effected. In this configuration, the finger 31 is also located in the teeth 1a of the wheel 11 and the roller 43 is located in a recess 33b of the cam 33.

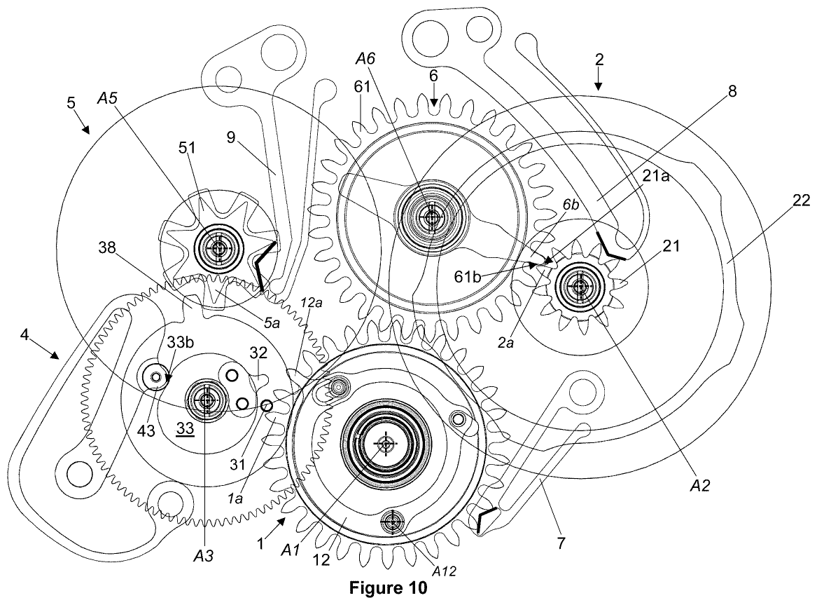

FIG. 10 represents the calendar system on May 1^{st}, just after midnight, namely just after the calendar indications jump. The roller 43 is located in the recess 33b of the cam 33 while the finger 6b is located in the teeth 2a and therefore constitutes an abutment against which a tooth 2a (the one following that which has just been driven) can abut.

FIGS. 11 to 13 represent the calendar system during the passage from May 30^{th} to May 31^{st}. During a first phase of the calendar indications jump depicted by FIGS. 11 and 12 the contact between the finger 32 and the tooth 12a retracts the lever 12 about the axis A12 because the pin 12b is free to move facing a circulation portion 22a of the month programming cam 22. The mobile 1 is therefore not driven in rotation about the axis A1. It is only when the finger 31 comes into contact with a tooth 1a of the wheel 11 that the mobile 1 can be driven by one angular step around the axis A1, thereby generating the change of date from May 30^{th} to May 31^{st}. As mentioned above, the circular portions 22a are therefore optional.

Regardless of the embodiment or the variant, the display member 23 is preferably a disc on which at least abutments 22b may be machined or mounted (the portions 22a being optional in the functioning of the calendar).

Regardless of the embodiment or the variant, the date of the month display member is preferably a hand 13, which makes it possible to minimize the inertia of the mobile 1. Alternatively, the member 13 could take the form of a disc.

Regardless of the embodiment or the variant, the indication of other temporal information is optional. This may for example mean a day indication as depicted. Additionally or alternatively, there can be a phase of the Moon indication, for example. In the particular situation of displaying the day represented in the figures, the finger 38 constitutes an abutment for the pinion 51, after the change of date, in particular of the teeth 5a as represented in FIG. 2. This operating principle therefore makes it possible to minimize the torque retaining the jumper 9 while preventing any risk of unintentional additional jumping of the day display member after the change of date.

Regardless of the embodiment or the variant, the month mobile and/or the day mobile can comprise pinions with a single tooth (as is the case of the pinion 21 represented in the figures) or duplicated teeth (as is the case of the pinion 51 represented in the figures). In this latter case duplicating the teeth makes it possible to optimize each of the sets of teeth with regard to their respective function. For example, the teeth 5a comprise teeth 51a including a succession of slots in order to cooperate as well as possible with the finger 38 of the mobile 3 and teeth 51b forming a star so as to cooperate optimally with the jumper beak 9.

Regardless of the embodiment or the variant, the mobile 1 (and the lever 12) are preferably driven directly by the elements 31 and 32 and therefore independently of any intermediate lever.

Regardless of the embodiment or the variant, the date mobile 1 can pivot about a first axis A1, the month mobile 2 can pivot about a second axis A2, and the drive mobile 3 can pivot about a third axis A3, the first axis A1, the second axis A2 and the third axis A3 preferably being distinct.

Regardless of the embodiment or the variant, the first axis A1 is preferably at the center of the calendar system 100 and/or at the center of the timepiece movement 200 and/or at the center of the timepiece 300.

Regardless of the embodiment or the variant, the timepiece calendar system 100 may comprise a frame 99 and the first and second axes may be fixed axes relative to the frame 99. In particular, the date wheel 1 can be pivoted directly on the frame 99 and the month cam can be pivoted directly on the frame 99.

Regardless of the embodiment or the variant, the timepiece calendar system 100 may be arranged so that the second element 12 for driving of the date mobile is freely retractable. By “freely retractable”, we mean that the calendar system has no spring to act against in order to retract the second date wheel drive element 12.

Regardless of the embodiment or the variant, the timepiece calendar system 100 may be arranged so that the second element 12 for driving of the date mobile acts directly by contact with the month cam 22.

Regardless of the embodiment or the variant, the mobile 2, notably the month mobile 2, includes:
the indicator disc, notably the month indicator disc 23, and
the cam, notably the month cam 22.

The mobile 2 can include any combination of the following features:
The indicator disc and the cam may form a one-piece assembly obtained by machining the whole from the mass or by fixing the month indicator disc and the month cam, in particular by gluing and/or welding and/or brazing. In some embodiments, the indicator disc and the cam can be made of different materials.
The cam may have an annular shape.
The indicator disc 23 may be inscribed in a first cylinder having a diameter D1, the cam 22 may be inscribed in a second cylinder having a diameter D2 and the cam may be an opening 221 in which a third cylinder having a diameter D3 can be inscribed, the diameters D1, D2 and D3 being such that
D2<D1, in particular D2<0.9×D1, and
D2>D3, in particular D2>D3>0.5×D2, in particular D2>D3>0.8×D2.
The cam 22 may be an annual month cam (12-month cam, making one complete revolution in 12 months).
The cam 22 may be arranged to rotate unidirectionally relative to the frame 99 about its axis A2, as may the other discs in the calendar system.

The date of the month and month indications (and possibly the day and phase of the Moon indications) can be corrected via the stem or by way of dedicated correctors.

Throughout this application, by “instantaneous jump” is preferably meant a jump with a duration of a few fractions of a second, typically of the order of approximately one hundredth of a second or approximately one twenty-fifth of a second or again approximately one tenth of a second.

In other words, the solutions described above are remarkable in that:
the month display member is driven instantaneously by the effect of the restoration of energy accumulated by the energy accumulator and by the calendar cam, the calendar being simple, annual, or perpetual, which makes it possible to arrive at the definition of a particularly highly performing complete calendar,
the months programming cam is off-center relative to the date mobile, which makes it possible to arrive at the definition of an annular or perpetual calendar that is particularly compact. The cam is advantageously included in the month display member, which enables further improvement in compactness while minimizing the inertia of the month mobile.

The solutions are also noteworthy in that the device enabling short months to be distinguished from long months is further simplified compared to the desmodromic device known from the application EP3567438A1, while being particularly compact thanks to the fact that the month programming cam is off-center relative to a date mobile and, all the more so, the fact that the latter is included in the month display member.

The solutions are simpler than those described in the application EP3567438 thanks to the fact that the tooth or the lever mounted to be mobile or movable on the date mobile cooperates directly with an off-center (or off-axis) month programming cam relative to the date mobile, independently of any cam follower. Such a month programming cam arrangement makes it possible to simplify, notably to make more compact, the chain connecting the date mobile to the mobile supporting said programming cam, notably with regard to that known from the application CH685585.

Of course, throughout this document, the expression “an element inscribed within a cylinder having a diameter D” means that the diameter D is the smallest diameter such that the element is included in the cylinder. Similarly, throughout this document, the expression “a cylinder having diameter D inscribed within an element” means that the diameter D is the biggest diameter such that the cylinder is included in the element.

1. An instantaneous jump timepiece calendar system comprising:
an energy accumulation and restoration device comprising an energy accumulator and a cam,
a date mobile,
a month mobile,
a first element for indexing the date mobile,
a second element for indexing the month mobile,
a mobile for driving the date mobile by restoring energy from the energy accumulator, and
an element for driving the month mobile by restoring energy from the energy accumulator,
the element for driving the month mobile being arranged and/or configured to limit the movement of the month mobile after the driving of the month mobile.

2. The timepiece calendar system according to claim 1, wherein the second indexing element for the month mobile produces a torque for holding the month mobile in tension 2 times less than a torque for retaining the date mobile in position produced by the first indexing element of the date mobile.

3. The timepiece calendar system according to claim 1, wherein the first indexing element is a jumper cooperating with teeth of the date mobile.

4. The timepiece calendar system according to claim 1, wherein the second indexing element is a jumper cooperating with teeth of the month mobile.

5. The timepiece calendar system according to claim 1, wherein the drive mobile comprises a first finger adapted to cooperate through contact with teeth of the date mobile.

6. The timepiece calendar system according to claim 1, wherein the drive mobile comprises a second finger adapted to cooperate through contact with an additional tooth of the date mobile.

7. The timepiece calendar system according to claim 1, wherein the drive mobile comprises the cam.

8. The timepiece calendar system according to claim 1, wherein the date mobile pivots about a first axis, the month mobile pivots about a second axis, and the drive mobile pivots about a third axis, the first axis, the second axis, and the third axis being distinct.

9. The timepiece calendar system according to claim 8, wherein the first axis is at a center of the calendar system and/or at a center of a timepiece movement and/or at a center of a timepiece.

10. The timepiece calendar system according to claim 1, wherein the element for driving the month mobile comprises a third finger adapted to cooperate through contact with teeth of the month mobile.

11. The timepiece calendar system according to claim 1, wherein the element for driving the month mobile comprises a first surface forming an abutment for the month mobile, the first surface being adapted to limit a movement of the month mobile by cooperating with a second surface of the month mobile.

12. The timepiece calendar system according to claim 1, wherein the system comprises:
a day mobile,
a third element for indexing the day mobile,
a third element for driving the day mobile by restoring energy from the energy accumulator.

13. The timepiece calendar system according to claim 1, wherein the third element for driving the day mobile is adapted and/or configured to limit a movement of the day mobile after the driving of the day mobile.

14. The timepiece calendar system according to claim 1, wherein the system is a simple or annual or semi-perpetual or perpetual calendar system.

15. A timepiece movement comprising a system according to claim 1.

16. A timepiece comprising a system according to claim 1.

17. The timepiece according to claim 15, which is a wristwatch.

18. The timepiece calendar system according to claim 1, wherein the second indexing element for the month mobile produces a torque for holding the month mobile in tension 1.5 times less than the torque for retaining the date mobile in position produced by the first indexing element of the date mobile.

19. The timepiece calendar system according to claim 2, wherein the first indexing element is a jumper cooperating with teeth of the date mobile.

20. The timepiece calendar system according to claim 5, wherein the first finger is a pin.
